(19) United States
(12) Patent Application Publication
(10) Pub. No.: US 2023/0043119 A1
(43) Pub. Date: Feb. 9, 2023

(54) LOW EMI DRIVER APPARATUS

(71) Applicant: Richtek Technology Corporation, Zhubei City (TW)

(72) Inventors: Hung-Yu Cheng, Taipei (TW); Chi-Hsun Wu, New Taipei (TW)

(21) Appl. No.: 17/749,052

(22) Filed: May 19, 2022

Related U.S. Application Data
(60) Provisional application No. 63/230,427, filed on Aug. 6, 2021.

(30) Foreign Application Priority Data
Apr. 19, 2022 (TW) 111114902

(51) Int. Cl. H02M 1/44; H02M 1/38; H02M 3/158

(52) U.S. Cl. CPC H02M 1/44; H02M 1/385; H02M 3/158

(57) ABSTRACT

A low EMI driver apparatus includes: a driver circuit configured to generate a driving signal according to a switch control signal, so as to drive at least one switch; and a driving strength control circuit configured to randomly control a driving strength of the driver circuit, thereby reducing an EMI generated when the at least one switch is driven according to the driving signal. In a specific form of the low EMI driver apparatus, the at least one switch includes plural switches, and the low EMI driver apparatus further includes: a dead time control circuit configured to randomly control a dead time between ON times of the plural switches, so as to reduce the EMI generated when the switches are driven according to the driving signal.

### CROSS REFERENCE

The present invention claims priority to U.S. 63/230,427 filed on Aug. 6, 2021 and claims priority to TW 111114902 filed on Apr. 19, 2022.

### BACKGROUND OF THE INVENTION

### Field of Invention

The present invention relates to a low EMI (ElectraMagnetic Interference) driver apparatus; particularly, it relates to such low EMI driver apparatus capable of reducing the EMI by random control of dead time and/or driving strength.

### Description of Related Art

Please refer to FIG. 1, which shows a schematic diagram of a conventional low EMI driver apparatus. The conventional low EMI driver apparatus 10 includes: a random number generator 101, an integrator 102, a variable capacitor 103 and a driver 104. The random number generator 101 generates a random number according to a clock signal CLK. The integrator 102 integrates the random number to generate a capacitor control signal VC. The capacitor control signal VC randomly fluctuates within a voltage range, so the capacitor control signal VC can control a capacitance of the variable capacitor 103 to randomly fluctuate within a range, to thereby reduce the electromagnetic interference (EMI).

The prior art low EMI driver apparatus 10 shown in FIG. 1 has a drawback that: the variable capacitor 103 consumes extra power, which is an undesirable waste.

In view of the above, to overcome the drawback in the prior art, the present invention proposes an innovated low EMI driver apparatus.

### SUMMARY OF THE INVENTION

From one perspective, the present invention provides a low EMI driver apparatus, comprising: a driver circuit, which is configured to operably generate a driving signal according to a switch control signal, so as to drive at least one switch; and a driving strength control circuit, which is configured to operably and randomly control a driving strength of the driver circuit, thereby reducing an EMI generated when the at least one switch is driven according to the driving signal.

In one embodiment, the driver circuit includes: a plurality of driving units connected in parallel to one another, which are configured to operably generate the driving signal according to the switch control signal, so as to drive the at least one switch; wherein the driving strength control circuit is configured to operably enable a random number of the driving units, so as to randomly control the driving strength, thereby reducing the EMI generated when the at least one switch is driven according to the driving signal.

In one embodiment, the driving strength control circuit generates the random number via a pseudo-random algorithm.

In one embodiment, the driving strength control circuit updates the random number according to a switching frequency of the switch control signal.

In one embodiment, a slew rate of the driving signal is correlated with the random number.

In one embodiment, the at least one switch includes a plurality of switches; wherein the low EMI driver apparatus further includes: a dead time control circuit, which is configured to operably and randomly control a dead time between ON times of the plurality of switches, so as to reduce the EMI generated when the switches are driven according to the driving signal.

From another perspective, the present invention provides a low EMI driver apparatus, comprising: a driver circuit, which is configured to operably generate a driving signal according to a switch control signal, so as to drive a plurality of switches; and a dead time control circuit, which is configured to operably and randomly control a dead time between ON times of the plurality of switches, so as to reduce an EMI generated when the switches are driven according to the driving signal.

In one embodiment, the dead time control circuit controls the dead time via a pseudo-random algorithm.

In one embodiment, the dead time control circuit updates the random number according to a switching frequency of the switch control signal.

Advantages of the present invention include: that the present invention can reduce the EMI without consuming too much extra power in average; and that the present invention does not require passive components which will result in extra power consumption.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic diagram of a conventional low EMI driver apparatus.

FIG. 2 shows a schematic circuit block diagram of a low EMI driver apparatus according to an embodiment of the present invention.

FIG. 3 shows a schematic circuit diagram of a driver circuit of a low EMI driver apparatus according to an embodiment of the present invention.

FIG. 4 and FIG. 5 depict diagrams of relevant signals in the operation of an embodiment of the present invention wherein the embodiment of FIG. 3 is applied to the low EMI driver apparatus of FIG. 2.

FIG. 6 shows a schematic circuit diagram of a driver circuit of a low EMI driver apparatus according to another embodiment of the present invention.

FIG. 7 and FIG. 8 depict diagrams of relevant signals in the operation of an embodiment of the present invention wherein the embodiment of FIG. 6 is applied to the low EMI driver apparatus of FIG. 2.

FIG. 9 shows a schematic circuit diagram of a driver circuit of a low EMI driver apparatus according to yet another embodiment of the present invention.

FIG. 10A to FIG. 10M show that the low EMI driver apparatus of the present invention can be applied to various types of switching power converters.

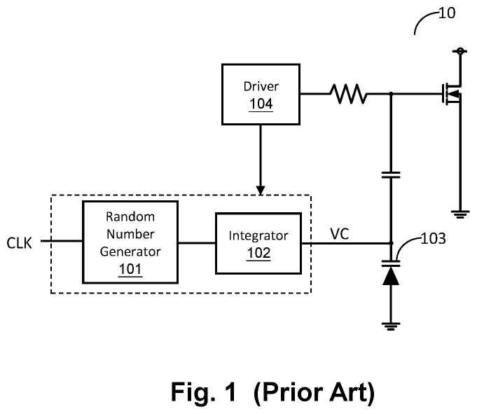

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

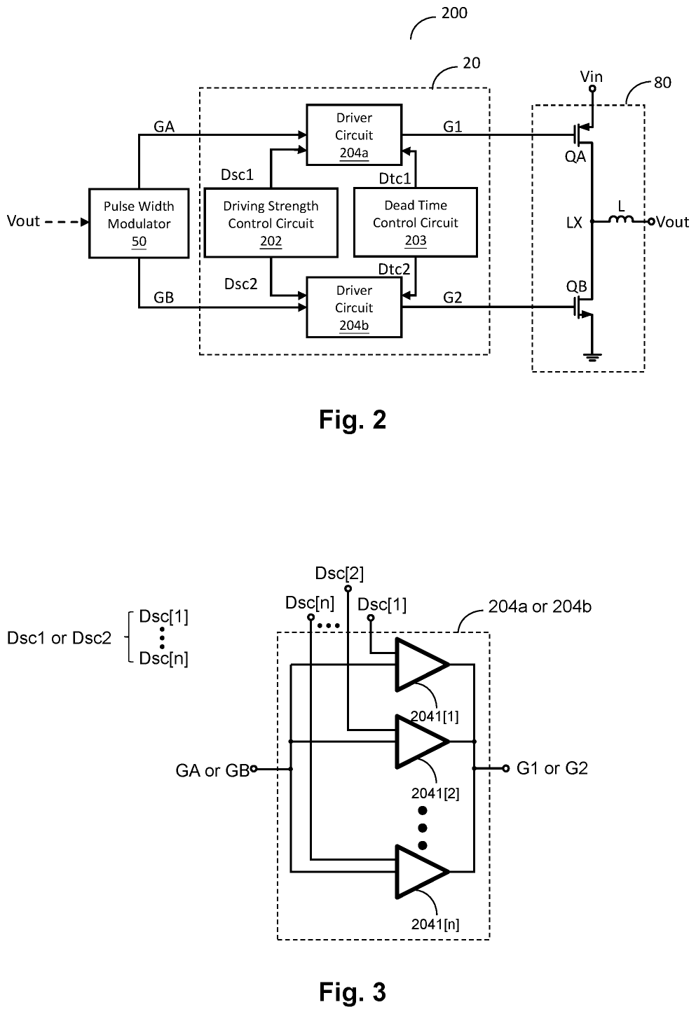

Please refer to FIG. 2, which shows a schematic circuit block diagram of a low EMI driver apparatus according to an embodiment of the present invention. As shown in FIG. 2, a buck converter 200 is configured to operably convert an input power (e.g., including an input voltage Vin) to an output power (e.g., including an output voltage Vout) by switching power conversion. In this embodiment, the buck converter 200 includes: a pulse width modulator 50, a low EMI driver apparatus 20 and a power stage 80. In one embodiment, the low EMI driver apparatus 20 of the present invention includes: a driving strength control circuit 202, a dead time control circuit 203 and driver circuits 204a and 204b. The pulse width modulator 50 is configured to operably generate a switch control signal GA and a switch control signal GB. The driver circuit 204a is configured to operably generate a driving signal G1 according to the switch control signal GA, whereas, the driver circuit 204b is configured to operably generate a driving signal G2 according to the switch control signal GB, so that the driver circuit 204a and the driver circuit 204b drive at least one switch in the power stage 80.

As shown in FIG. 2, in one embodiment, the above-mentioned at least one switch includes plural switches QA and QB. In the embodiment shown in FIG. 2, the switch QA is coupled between the input voltage Vin and a first end (i.e., a switching node LX) of an inductor L, whereas, the switch QB is coupled between a ground level and the first end (i.e., the switching node LX) of the inductor L. The driving signal G1 and the driving signal G2 are configured to operably control the switch QA and the switch QB, respectively, so as to switch the first end (i.e., the switching node LX) of the inductor L between the input voltage Vin and the ground level. Another end of the inductor L is coupled to the output voltage Vout. Thus, the input voltage Vin is converted to the output voltage Vout.

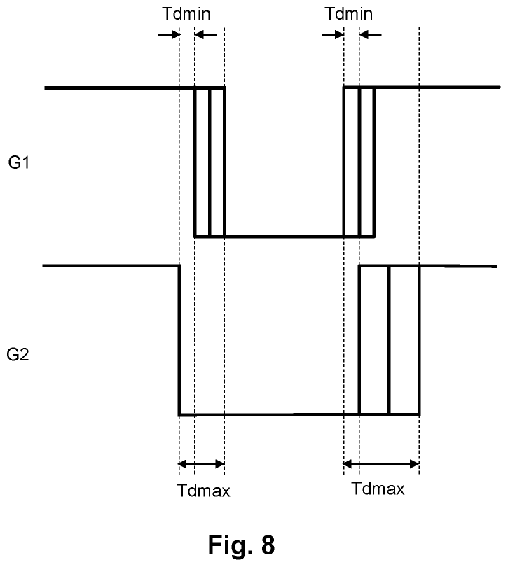

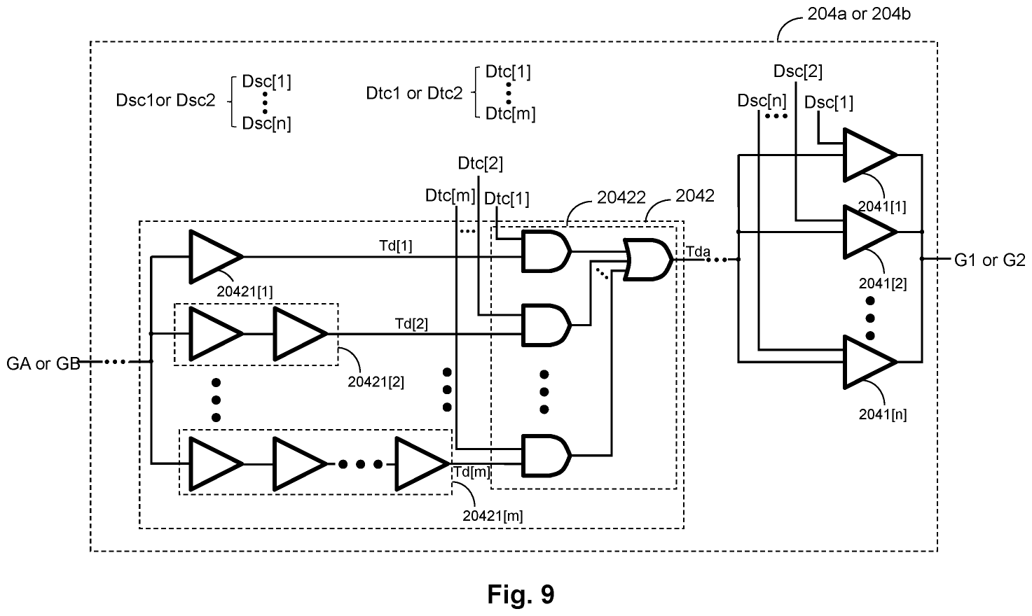

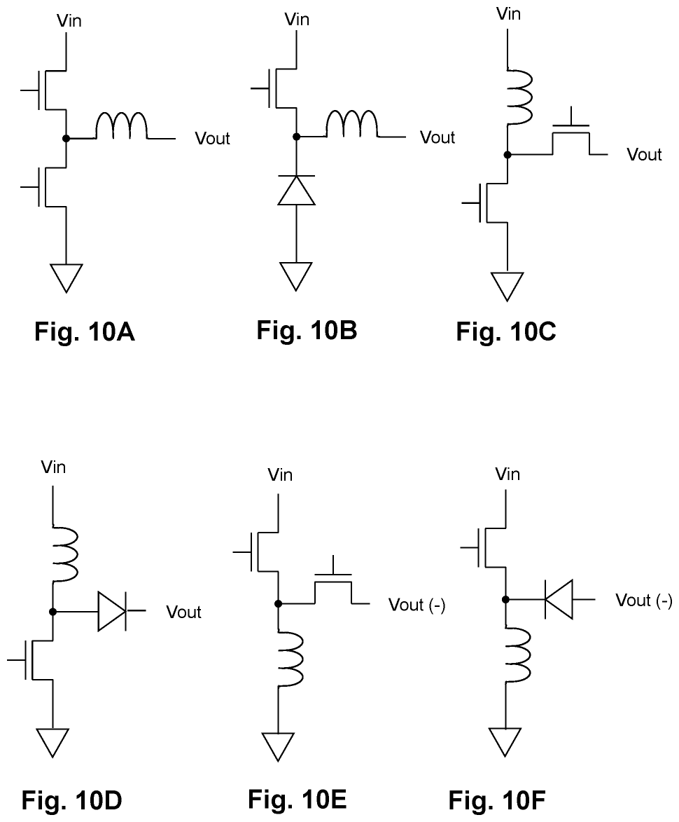

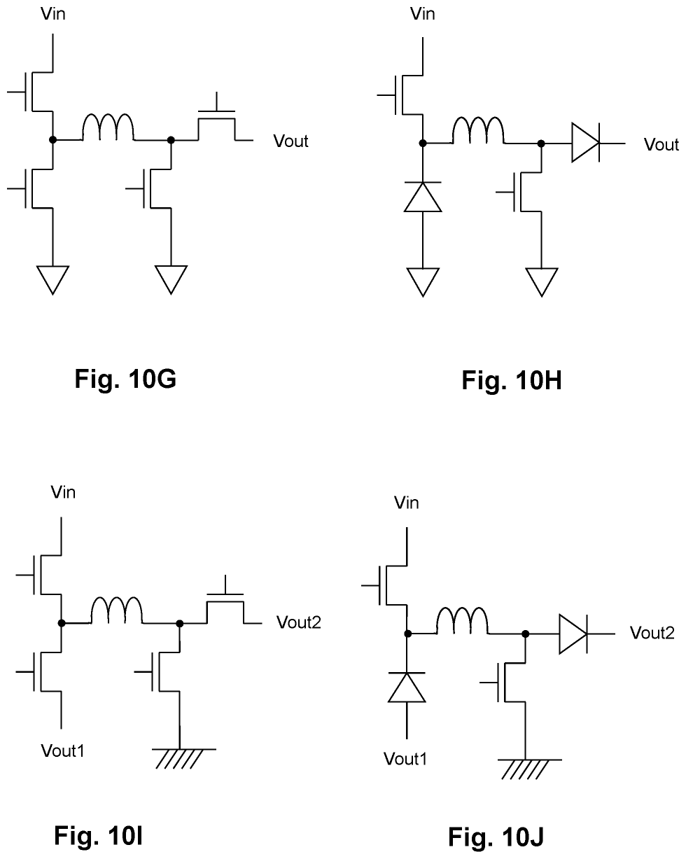

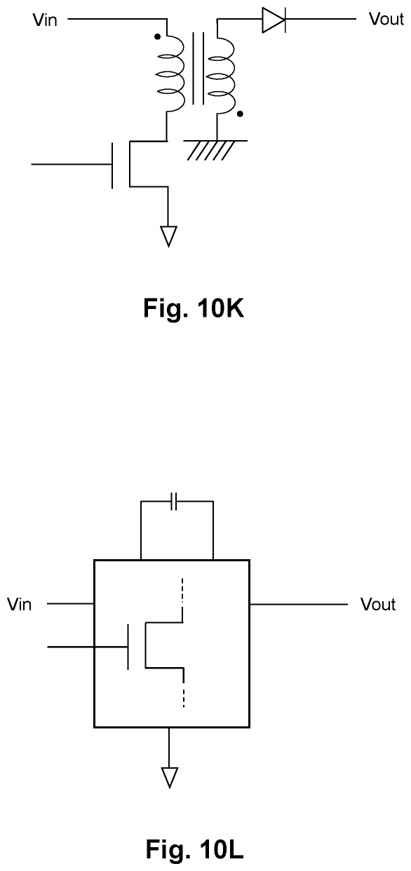

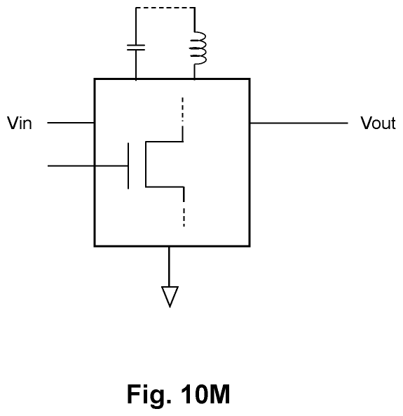

In other words, as shown in FIG. 2, the switch QA, the switch QB and the inductor L constitute a power stage 80 of a buck converter. It is worthwhile mentioning that, the low EMI driver apparatus 20 of the present invention can be applied to any type of power stage of a switching power converter circuit. To be more specific, as shown in FIG. 10A to FIG. 10M, the low EMI driver apparatus 20 of the present invention can be applied to, for example but not limited to, a boost converter, a buck converter, a buck-boost converter, a switched-capacitor converter and a switched tank converter (STC).

The driving strength control circuit 202 is configured to operably generate a driving strength control signal Dsc1 and a driving strength control signal Dsc2, so as to randomly control a driving strength of the driver circuit 204a and a driving strength of the driver circuit 204b according to the driving strength control signal Dsc1 and the driving strength control signal Dsc2 during each adjustment period, respectively, so that the driver circuit 204a and the driver circuit 204b respectively drive the switch QA and the switch QB by driving strengths which vary randomly, thereby reducing the EMI generated when the switch QA and the switch QB are switched according to the switch control signal GA and the switch control signal GB (i.e., corresponding to the driving signal G1 and the driving signal G2). The above-mentioned adjustment periods are correlated to a switching period of the driving signal G1 (i.e., corresponding to a switching frequency and a switching period of the switch control signal GA) and a switching period of the driving signal G2 (i.e., corresponding to a switching frequency and a switching period of the switch control signal GB). In one embodiment, preferably, the above-mentioned adjustment periods are the switching period of the driving signal G1 and the switching period of the driving signal G2. That is, the driving strength of the driver circuit 204a and the driving strength of the driver circuit 204b are randomly adjusted during each adjustment period.

In one embodiment, a slew rate of the driving signal G1 and a slew rate of the driving signal G2 are correlated with a random number. In one embodiment, preferably, the slew rate of the driving signal G1 and the slew rate of the driving signal G2 are proportional to the above-mentioned random number.

In one embodiment, the dead time control circuit 203 is configured to operably generate a dead time control signal Dtc1 and a dead time control signal Dtc2, so as to randomly and respectively control the driver circuit 204a and the driver circuit 204b according to the dead time control signal Dtc1 and the dead time control signal Dtc2 during a dead time between an ON time of the switch QA and an ON time of the switch QB, thereby reducing the EMI generated when the switch QA and the switch QB are switched according to the driving signal G1 and the driving signal G2, respectively. In one embodiment, the dead time control circuit 203 controls the dead time via a pseudo-random algorithm. In one embodiment, the dead time control circuit 203 updates the dead time according to the switching frequency of the switch control signal GA and the switching frequency of the switch control signal GB.

In one embodiment, the above-mentioned two approaches of randomly controlling the driving strength and randomly controlling the dead time can be executed alone but not in combination. That is, the low EMI driver apparatus 20 can just randomly control the driving strength of the driver circuit 204a or the driving strength of the driver circuit 204b, but does not randomly control the dead time of the driver circuit 204a or the dead time of the driver circuit 204b. In another embodiment, the low EMI driver apparatus 20 can just randomly control the dead time of the driver circuit 204a or the dead time of the driver circuit 204b, but does not randomly control the driving strength of the driver circuit 204a or the driving strength of the driver circuit 204b.

Please refer to FIG. 3, which shows a schematic circuit diagram of a driver circuit of a low EMI driver apparatus according to an embodiment of the present invention. As shown in FIG. 3, in one embodiment, each of the driver circuit 204a and the driver circuit 204b includes: driving units 2041[1]˜2041[n] connected in parallel to one another, wherein the driving units 2041[1]˜2041[n] connected in parallel to one another are configured to operably generate the driving signal G1 or G2 according to the switch control signal GA or GB, so as to drive the switch QA or QB.

Please refer to FIG. 2 in conjugation with FIG. 3. Each of the driving strength control signal Dsc1 and the driving strength control signal Dsc2 includes driving strength control signals Dsc[1]˜Dsc[n]. The driving strength control signal Dsc1 or the driving strength control signal Dsc2 generated by the driving strength control circuit 202 is configured to operably enable a random number of the plural driving units 2041[1]˜2041[n], thereby reducing the EMI generated when the switch QA and the switch QB are switched according to the driving signal G1 and the driving signal G2, respectively, wherein n is a positive integer greater than one. A random number of the driving strength control signals Dsc[1]˜Dsc[n] are controlled to be at enable level (e.g., high level) by the driving strength control circuit 202, so as to enable the corresponding driving units. When more driving units are enabled by the driving strength control signal Dsc1 or the driving strength control signal Dsc2, the driving strength of the driver circuit 204a or the driving strength of the driver circuit 204b becomes greater, and when less driving units are enabled by the driving strength control signal Dsc1 or the driving strength control signal Dsc2, the driving strength of the driver circuit 204a or the driving strength of the driver circuit 204b becomes less. Please refer to FIG. 2 in conjugation with FIG. 3. The driving strength control circuit 202 generates the above-mentioned random number via a pseudo-random algorithm. In one embodiment, the driving strength control circuit 202 updates the above-mentioned random number according to a switching frequency (corresponding to the above-mentioned switching period of the driving signal G1) of the switch control signal GA and a switching frequency (corresponding to the above-mentioned switching period of the driving signal G2) of the switch control signal GB.

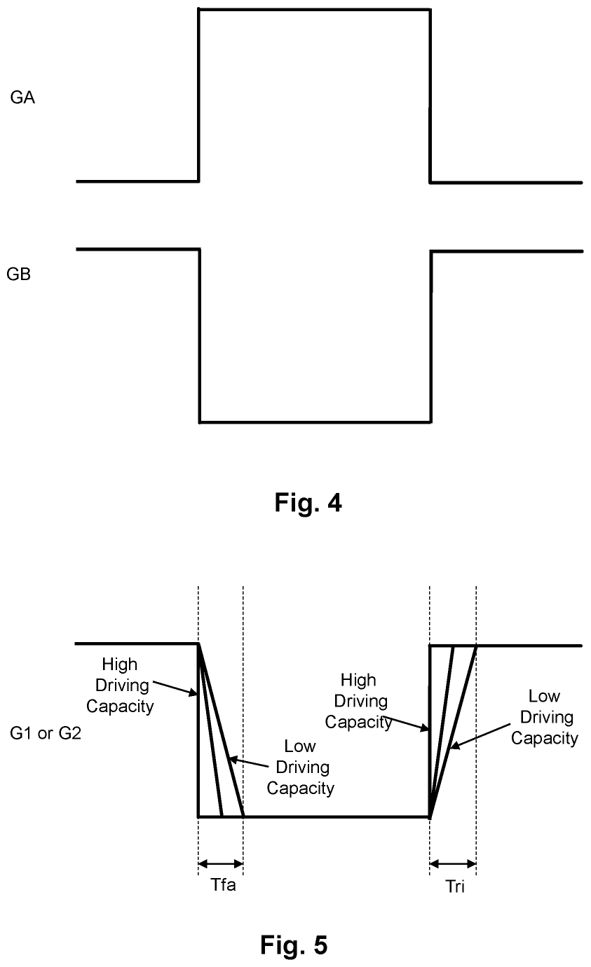

Please refer to FIG. 4 and FIG. 5, which show diagrams of the switch control signals GA and GB and the driving signal G1 or G2 in the operation of an embodiment of the present invention wherein the embodiment of FIG. 3 is applied to the low EMI driver apparatus of FIG. 2. Please refer to FIG. 2 in conjugation with FIG. 5. The waveform of the driving signal G1 or the driving signal G2 randomly changes during a falling period Tfa or a rising period Tri as the driving strength of the driver circuit 204a or the driver circuit 204b is randomly controlled by the driving strength control circuit 202. Faster rising speed or falling speed of the driving signal G1 or G2 indicates that the driving strength of the driver circuit 204a or 204b is greater, and slower rising speed or falling speed of the driving signal G1 or G2 indicates that the driving strength of the driver circuit 204a or 204b is weaker. In one embodiment, when the switch control signal GA is at high level, the switch QA is controlled to be ON, and, when the switch control signal GB is at high level, the switch QB is controlled to be ON. In one embodiment, the level of the switch control signal GA and the level of the switch control signal GB are complementary to each other, so that the switch QA and the switch QB switch complementarily.

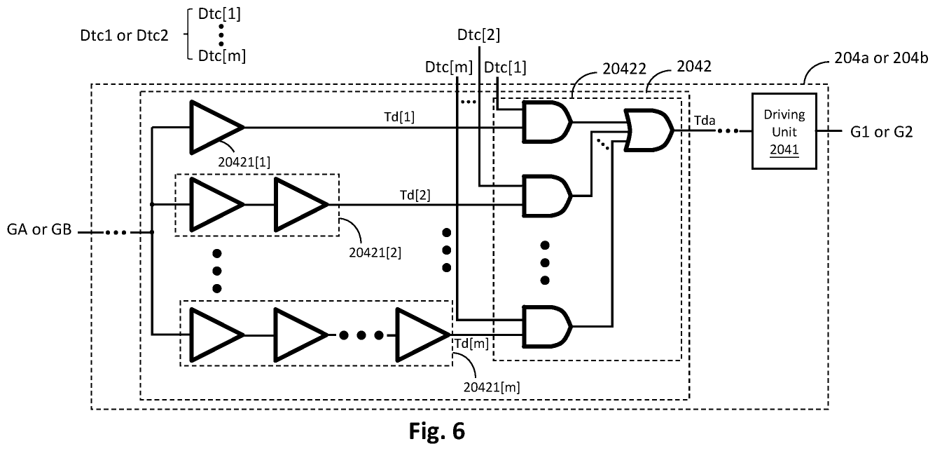

Please refer to FIG. 6, which shows a schematic circuit diagram of a driver circuit of a low EMI driver apparatus according to another embodiment of the present invention. As shown in FIG. 6, in one embodiment, the driver circuit 204a or 204b includes: a driving unit 2041 and an adjustable delay circuit 2042. The adjustable delay circuit 2042 includes: delay time generation circuits 20421[1]˜20421[m] and a delay time selection circuit 20422. The delay time generation circuits 20421[1]˜20421[m] are configured to operably generate delay signals Td[1]˜Td[m] respectively according to the switch control signal GA or the switch control signal GB. The delay time selection circuit 20422 is configured to operably and randomly select one of the delay signals Td[1]˜Td[m] according to the dead time control signal Dtc1 or the dead time control signal Dtc2, so as to generate an adjustable delay signal Tda, wherein each of the dead time control signal Dtc1 and the dead time control signal Dtc2 includes dead time control signal Dtc[1]˜Dtc[m]. The driving unit 2041 generates the adjustable delay signal Tda according to the delay time which has been randomly selected according to the randomly selected delay signals Td[1]˜Td[m], so as to control the dead time between the driving signal G1 and the driving signal G2 to have a random time length.

In one embodiment, each of the delay time generation circuit 20421[1]˜20421[m] includes a buffer unit or plural buffer units connected in series, wherein the buffer unit or the buffer units connected in series are configured to operably generate corresponding delay times having different time lengths, so as to generate corresponding delay signals Td[1]˜Td[m]. In one embodiment, the dead time control circuit 203 randomly controls one of the dead time control signals Dtc[1]˜Dtc[m] to become high level by, wherein m is a positive integer greater than one. In one embodiment, the delay time selection circuit 20422 includes an AND gate and an OR gate. The driving unit 2041 is configured to operably generate the driving signal G1 or the driving signal G2 according to the adjustable delay signal Tda.

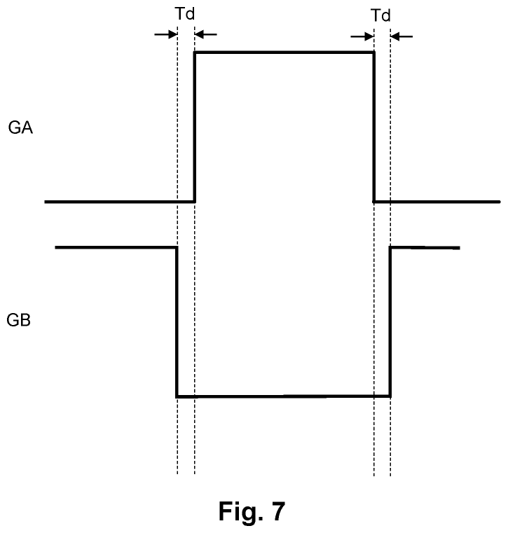

Please refer to FIG. 7 and FIG. 8, which show diagrams of the switch control signals GA and GB and the driving signals G1 and G2 in the operation of an embodiment of the present invention wherein the embodiment of FIG. 6 is applied to the low EMI driver apparatus of FIG. 2. As shown in FIG. 2 and FIG. 7, in one embodiment, there is a dead time Td between the switch control signal GA and the switch control signal GB. Because the switch control signal GA and GB have not yet passed through the driver circuit 204a and 204b, the dead time Td in the waveforms of the switch control signals GA do not vary, that is, the dead time Td which lies between the switch control signal GA and the switch control signal GB is a constant. Please refer to FIG. 7, the dead time Td indicates a time interval which lies between a rising edge of the switch control signal GA and a falling edge of the switch control signal GB, and in one embodiment, the dead time Td is also the time interval between a falling edge of the switch control signal GA and a rising edge of the switch control signal GB. Please refer to FIG. 2 in conjugation with FIG. 6 and FIG. 8. Because the dead time control circuit 203 randomly controls the delay time of the adjustable delay circuit 2042 in the driver circuit 204a or 204b, the length of the dead time between the driving signal G1 and the driving signal G2 will randomly change accordingly. FIG. 8 illustrates that the dead time can be randomly changed between a maximum dead time Tdmax and a minimum dead time Tdmin.

Please refer to FIG. 9, which shows a schematic circuit diagram of a driver circuit of a low EMI driver apparatus according to yet another embodiment of the present invention. This embodiment not only randomly both the dead time of the driver circuit 204a or 204b, but also randomly controls the driving strength of the driver circuit 204a or 204b. As shown in FIG. 9, in this embodiment, each of the driver circuit 204a and the driver circuit 204b includes driving units 2041[1]˜2041[n] connected in parallel to one another and an adjustable delay circuit 2042. The driving units 2041[1]˜2041[n] of this embodiment shown in FIG. 9 are similar to the driving units 2041[1]˜2041[n] of the embodiment shown in FIG. 3, so the details thereof are not redundantly repeated here. The adjustable delay circuit 2042 of this embodiment shown in FIG. 9 is similar to the adjustable delay circuit 2042 of the embodiment shown in FIG. 6, so the details thereof are not redundantly repeated here.

The low EMI driver apparatus of the present invention is capable of reducing the EMI through randomly controlling the dead time and/or randomly controlling the driving strength. As a result, the present invention can reduce the EMI without consuming too much extra power in average; and the present invention does not require passive components which will result in extra power consumption.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A low EMI driver apparatus, comprising:
a driver circuit, which is configured to operably generate a driving signal according to a switch control signal, so as to drive at least one switch; and
a driving strength control circuit, which is configured to operably and randomly control a driving strength of the driver circuit, thereby reducing an EMI generated when the at least one switch is driven according to the driving signal.

2. The low EMI driver apparatus of claim 1, wherein the driver circuit includes:
a plurality of driving units connected in parallel to one another, which are configured to operably generate the driving signal according to the switch control signal, so as to drive the at least one switch;
wherein the driving strength control circuit is configured to operably enable a random number of the driving units, so as to randomly control the driving strength, thereby reducing the EMI generated when the at least one switch is driven according to the driving signal.

3. The low EMI driver apparatus of claim 2, wherein the driving strength control circuit generates the random number via a pseudo-random algorithm.

4. The low EMI driver apparatus of claim 3, wherein the driving strength control circuit updates the random number according to a switching frequency of the switch control signal.

5. The low EMI driver apparatus of claim 2, wherein a slew rate of the driving signal is correlated with the random number.

6. The low EMI driver apparatus of claim 1, wherein the at least one switch includes a plurality of switches;
wherein the low EMI driver apparatus further includes:
a dead time control circuit, which is configured to operably and randomly control a dead time between ON times of the plurality of switches, so as to reduce the EMI generated when the switches are driven according to the driving signal.

7. The low EMI driver apparatus of claim 6, wherein the dead time control circuit controls the dead time via a pseudo-random algorithm.

8. The low EMI driver apparatus of claim 7, wherein the dead time control circuit updates the random number according to a switching frequency of the switch control signal.

9. A low EMI driver apparatus, comprising:
a driver circuit, which is configured to operably generate a driving signal according to a switch control signal, so as to drive a plurality of switches; and
a dead time control circuit, which is configured to operably and randomly control a dead time between ON times of the plurality of switches, so as to reduce an EMI generated when the switches are driven according to the driving signal.

10. The low EMI driver apparatus of claim 9, wherein the dead time control circuit controls the dead time via a pseudo-random algorithm.

11. The low EMI driver apparatus of claim 10, wherein the dead time control circuit updates the random number according to a switching frequency of the switch control signal.
